(19) United States
(12) Patent Application Publication
(10) Pub. No.: US 2013/0290245 A1
(43) Pub. Date: Oct. 31, 2013

(54) DATABASE HISTORY MANAGEMENT METHOD AND SYSTEM THEREOF

(71) Applicant: LG CNS CO., LTD., Seoul (KR)

(72) Inventors: Deok Young HWANG, Seoul (KR); Jeong Hyun WI, Seoul (KR); Jung In PARK, Seoul (KR); Joon Ik LEE, Seoul (KR); Hye Kyoung CHON, Seoul (KR); Chun Sik LEE, Seoul (KR)

(73) Assignee: LG CNS CO., LTD., Seoul (KR)

(21) Appl. No.: 13/871,916

(22) Filed: Apr. 26, 2013

(30) Foreign Application Priority Data
Apr. 26, 2012 (KR) 10-2012-0044129

(51) Int. Cl. G06F 17/30

(52) U.S. Cl. CPC G06F 17/30002
USPC 707/609

(57) ABSTRACT

Disclosed is a technology of managing a database. A database history management system includes at least one management object database server and a master management server for managing a history of the at least one management object database server. The database history management system includes at least one management object DB server and a master management server. The at least one management object database server establishing a management object database, and generating or updating a history database with respect to the management object database according to the history policy from the master management server. The master manager server manages a history policy with respect to the at least one management object database server, and accesses the at least one management object database server to remotely manage a history database with respect to a corresponding management object database. It is unnecessary to establish a separate server and there is no problem in a network load, and collected data can be rapidly inquired by constructing a history DB in each DB server

### TECHNICAL FIELD

The present invention relates a technology of managing a database (hereinafter referred to as ‘DB’). More particularly, the present invention relates to a database history management method capable of evaluating a remotely accessed DB system using various evaluation items with respect to the DB system and a DB history management system thereof.

### BACKGROUND ART

With the rapid development of a computing environment, a DB system has been developed while gradually satisfying high capacity and diversity. To meet such a demand, there is a need for a technology capable of managing a DB system from a remote place physically spaced from the DB system.

Accordingly, there are various demands for a DB management technology which remotely accesses the DB system to diagnose or evaluate a corresponding DB system.

However, since a DB management technology, particularly, technologies of managing a history of the DB according to the related art collect real time data of a management object DB from a master server to inquire history data, there is a need for a separate master server. Accordingly, the cost is incurred to establish an additional server for collecting performance data. Since performance data are periodically collected from a plurality of management object DBs, a network load is incurred. A space issue of a master server is incurred. Since the master server must inquire the collected data, a rate is reduced. When data stop due to failure of a network or a management DB, change in a next history cannot be known.

### DISCLOSURE

### Technical Problem

The present invention has been made in an effort to provide a database history management method where it is unnecessary to establish a separate server and there is no problem in a network load, and collected data may be rapidly inquired by constructing a history DB in each DB server, and a DB history management system thereof.

The present invention further provides a DB history management method capable of easily changing a collection period of performance data collected in a history DB and of easily setting a type of performance data and a retention period of collected data because a master server may manage a history policy for establishing a history DB with respect to each DB server, and a DB history management system thereof.

The present invention further provides a DB history management method capable of confirming a log record with respect to a history policy by separately providing a master DB storing information on the history policy with respect to a master server, and of providing data of a DB server or history data through an application unit included in the master server as easy interface, and a DB history management system thereof.

### Technical Solution

A database history management system includes at least one management object database server and a master management server for managing a history of the at least one management object database server. The database history management system includes at least one management object DB server and a master management server. The at least one management object database server establishing a management object database, and generating or updating a history database with respect to the management object database according to the history policy from the master management server. The master manager server manages a history policy with respect to the at least one management object database server, and accesses the at least one management object database server to remotely manage a history database with respect to a corresponding management object database.

In an embodiment, the history policy may include at least one of item information on the management object database, and update period information and a meta data type on the history database.

The management object database server may extract data corresponding to an item corresponding to item information for each update period from the management object database according to the history policy to store the extracted data in a meta data format and to generate the history database.

The management object database server may include a database manager managing accessing the management object database or the history database; and a history database generator extracting predetermined data from the management object database according to the history policy to generate the history database.

The master management server may include: a master database storing information on the history policy; and an application unit forming a session with the management object database server, and providing and requesting information on the history policy to a corresponding management object database server connected by the session so that the history data is configured.

The application unit may include a history database management module managing at least one of registration, variation, or deletion of the history database; and a configuration information setting module inquiring the preset information of the data stored in the history database, and generating or correcting the history policy.

The application unit may further include a history information inquiry module performing graphic processing with respect to data acquired from the history database to generate reporting data.

The application unit may further include a history information inquiry module inquiring session information on a corresponding time with respect to a session to which an error record is set among data stored in the history database.

A management object database server may connect with a master management server for managing a history of a management object database server and establishes and maintains a predetermined management object database. The management object database server may include a management object database storing predetermine data. A history database generator may extract predetermined data from the management object database according to the history policy from the master management server to generate the history database. A history database stores the history data generated by the history database generator.

The management object database server may further include a database manager forming a predetermined session for communication with the management object database server, and managing accessing the management object database or the history database by the master management server.

The history policy may include at least one of item information on the management object database, and update period information and a meta data type on the history database.

A master management server establishes a management object database and is connected to at least one management object database server including a history database with respect to the management object database. The master management server includes a master database and an application unit. The master database may store a history policy for configuring the history database. The application unit may set the history policy, inquire preset information of data stored in a history database established in the connected management object data or generate or correct the history policy.

The application unit may include a history database management module managing at least one of registration, variation, or deletion of the history database; and a configuration information setting module inquiring the preset information of the data stored in the history database, and generating or correcting the history policy.

The application unit may further include a history information inquiry module performing graphic processing with respect to data acquired from the history database to generate reporting data, and inquiring session information on a corresponding time with respect to a session to which an error record is set among data stored in the history database.

A database history management method is performed by a management object database server for managing a history of a management object database server and establishing and maintaining a predetermined management object database. The database history management method includes: (a) receiving a history policy from the master management server; (b) extracting at least some data of the management object database according to the history policy to establish a history database; and (c) providing data stored in the established history data in response to a request from the master management server.

The history policy may include at least one of item information on the management object database, and update period information and a meta data type on the history database, and step (b) may include: extracting data corresponding to an item corresponding to item information from the management object database according to the history policy; re-extracting data corresponding to an update period according to update period information with respect to the data corresponding to the extracted item; and converting the extracted data in a meta data format.

A database history management method is performed by a master management server establishing a management object database and being connected to at least one management object database server including a history database with respect to the management object database. The database history management method includes: (a) setting a history policy for respectively or commonly establishing the history database to the at least one management object database server; (b) storing information on the set history policy to establish a master database; and (c) inquiring preset information of data stored in the history database established in the at least one management object database, and correcting the history policy in response to a request to request correction of the preset information.

The database history management method may further include: (d1) accessing the history database of the at least one management object database server to extract predetermined history data; and generating reporting data with respect to the extracted history data.

The database history management method may further include (d2) inquiring and providing session information on a corresponding time with respect to a session to which an error record is set among the data stored in the history DB.

A recording medium recording a program for executing a database history management method, the program being driven by a master management server establishing a management object database and being connected to at least one management object database server including a history database with respect to the management object database, the program comprising: (a) a function of setting a history policy for respectively or commonly establishing a history database to the at least one management object database server; (b) a function of storing information on the set history policy to configure a master database; and (c) a function of inquiring preset information of data stored in the history database established in the at least one management object database, and correcting the history policy in response to a request to request correction of the preset information.

### Advantageous Effects

According to the present invention, it is unnecessary to establish a separate server and there is no problem in a network load, and collected data can be rapidly inquired by constructing a history DB in each DB server.

Further, according to the present invention, since a master server may manage a history policy for establishing a history DB with respect to each DB server, a collection period of performance data collected in a history DB can be easily changed and a type of performance data and a retention period of collected data can be easily set.

In addition, according to the present invention, a log record can be confirmed with respect to a history policy by separately providing a master DB storing information on the history policy with respect to a master server, and data of a DB server or history data through an application unit included in the master server can be provided as easy interface.

### BRIEF DESCRIPTION OF THE DRAWINGS

FIG. 1 is a reference diagram illustrating a DB history management system according to an embodiment of the present invention.

FIG. 2 is a block diagram illustrating a configuration of a management object DB server according to an embodiment of the present invention.

FIG. 3 is a block diagram illustrating a configuration of a master management server according to an embodiment of the present invention.

FIG. 4 is a block diagram illustrating a detail configuration of an application unit of the master management server.

FIG. 5 is a block diagram illustrating a DB history management system according to an embodiment of the present invention.

FIG. 6 is a flowchart illustrating a DB history management method performed by a management object DB server according to an embodiment of the present invention.

FIG. 7 is a flowchart illustrating a DB history management method performed by a master management server according to an embodiment of the present invention.

FIGS. 8 to 12 are reference diagrams illustrating an example of a DB management picture according to an embodiment of the present invention.

### BEST MODE

Although a preferred embodiment of the disclosure has been described for illustrative purposes, those skilled in the art will appreciate that various modifications, additions and substitutions are possible, without departing from the scope and spirit of the invention as disclosed in the accompanying claims.

Meanwhile, Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component.

In addition, when a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Reference numerals (e.g., a, b, c, etc.) in respective steps are used for the purpose of description, and do not represent an order of the respective steps, the respective steps. If a specific order is not depicted, the respective steps may be perform differently from a specified order. That is, the respectively steps may be performed really and simultaneously or be performed in a reverse order according to a corresponding function.

The present invention may be implemented by a computer readable code in a computer readable recording medium. The computer readable recording medium includes various types of recording devices storing data which may be read by a computer system. For example, the computer readable recording medium includes ROM, RAM, CD-ROM, magnetic tape, floppy disk, and optical data storage device. Moreover, the computer readable recording medium may be implemented in the form of a carrier wave (e.g., transmission through internet). In addition, the computer readable recording medium is distributed to a computer system connecting with the network so that a computer readable code may be stored and executed in a distribution scheme.

Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

FIG. 1 is a reference diagram illustrating a DB history management system according to an embodiment of the present invention.

Hereinafter, it is assumed that a DB server 100 being a management object according to the present invention refers to a management object DB server 100.

The DB history management system includes at least one management object DB server 100 and a master management server 200. According to the embodiment, the DB history management system may further include a manager terminal 300.

The management object DB server 100 may establish a management object DB. The management object DB is not limited to a specific type of DB as a DB being a management object.

The management object DB server 100 may generate or update a history DB storing history information with respect to a management object DB. The management object DB server 100 may receive predetermined information from the master management server 200 to generate a history DB.

The management object DB server 100 may establish a management object DB 120, and generate or update a history DB with respect to a management object DB according to a history policy provided from the master management server 200.

In one embodiment, the history policy may include at least one of item information on the management object DB 120, and update period information and a meta data type on the history DB 140.

In the embodiment, the management object DB server 100 may extract data corresponding to an item corresponding to item information for each update period from the management object DB 120 according to the history policy to store the extracted data in a meta data format and to generate the history DB 140.

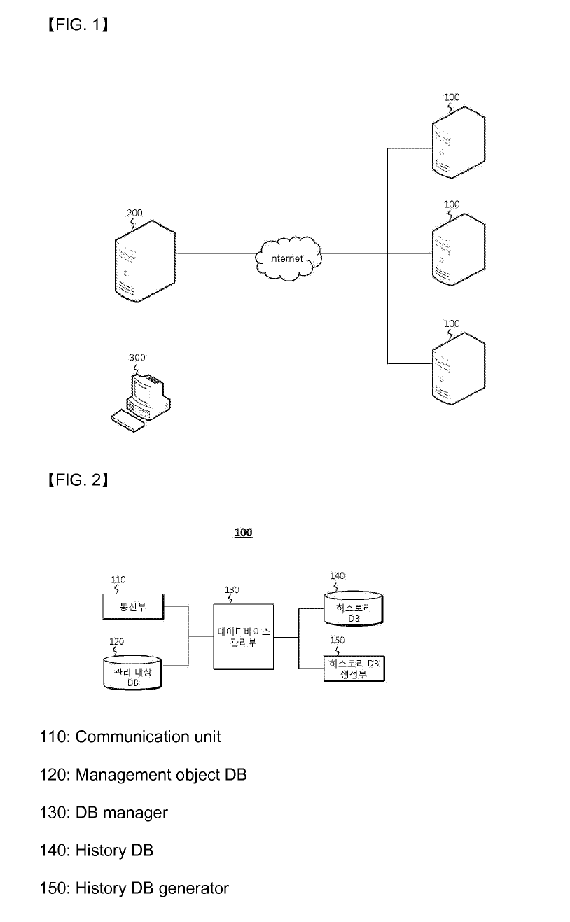

The management object DB server 100 will now be described in detail with reference to FIG. 2.

The master management server 200 may access the at least one management object DB server 100 to manage a DB using information on the management object DB.

The master management server 200 may request the management object DB server 100 to generate or update the history DB.

The master management server 200 may access a history DB or a management object DB of the management object DB server 100 to perform a predetermined management function.

The master management server 200 may manage a history policy with respect to the at least one management object DB server 100, and accesses the at least one management object DB server 100 to remotely manage a history DB with respect to a corresponding management object DB.

The master management server 200 will now be described in detail with reference to FIG. 3.

The manager terminal 300 may serve as a terminal side of a DB manager with respect to the master management server 200.

The manager terminal 300 may be configured separately from the master management server 200 as shown, or be configured as one logically configured device.

FIG. 2 is a block diagram illustrating a configuration of a management object DB server according to an embodiment of the present invention.

In detail referring to FIG. 2, the management object DB server 100 may include a communication unit 110, a management object DB 120, a DB manager 130, and a history DB 140. In the embodiment, the management object DB server 100 may further include a history DB generator 150.

The communication unit 110 may form a communication session with the master management server 200 to generate or maintain a communication environment.

The management object DB is a data which is a management object established in the management object DB server 100. As illustrated above, the present invention does not limit a function, a configuration, or a standard with respect to the management object DB 120.

The master management server 200 may access the management object DB 120 under control of the DB manager 130.

The DB manager 130 may control accessing a DB established in the management object DB server 100. For example, the DB manager 130 may manage accessing the management object DB 120 or the history DB 140.

The DB manager 130 may provide information (capacity information, failure information, etc.) on a DB established in the management object DB server in response to a request of the master management server 200.

In the embodiment, the DB manager 130 may be configured by an SQL Server. The SQL Server is a DB Management System (MS) operating by a plurality servers, and may process all DB requests to be performed in the management object DB server 100. For example, the SQL Server may perform management with respect to user log-in/log-out and DB access of a session accessing the management object DB server 100, and access authorization management with respect to the history DB.

The history DB 140 may store history data (performance data) with respect to the management object DB 120.

In the embodiment, the history DB 140 may store information on a history policy.

In the embodiment, the history DB 140 may set whether a history DB 140 is used, change a collection period of performance data collected in the history DB 140, select a type of performance data, set a retention period of collected performance data, rapidly inquire recent data by setting a partition function to the history DB 140, and configure a history data environment suited to an environment of each DB server by limiting the size of the history DB 140 in response to a request of the master management server 200.

In the embodiment, the history DB 140 may set a partition function based on information on a storage time to provide rapid search when storing history data (performance data).

The history DB generator 150 may extract predetermined data from the management object DB 120 according to the history policy to generate the history DB 140.

In the embodiment, the history DB generator 150 may automatically generate or update a history policy based on information on the history policy. For example, when the history policy is not valid (for example, including termination of the history policy and invalid items), the history DB generator 150 may confirm information on an existing history policy, analyze recent N history policies, and generate a new valid history policy based thereon.

In the embodiment, the history DB generator 150 may generate a new valid history policy including a commonly selected predetermined item among the recent N history policies.

In the embodiment, the history DB generator 150 may store history data (performance data) in the history DB 140 by setting a partition based on information on a storage time.

In the embodiment, the history DB generator 150 may store data in the history DB 140 according to a preset history policy independently from a connection state with the master management server 200. In the embodiment, even when failure occurs between the master management server 200 and the management object DB server 100 due to a network, history data may be validly recorded so that stable history management is possible unlike the related art.

In the embodiment, when a preset history policy is invalid, the history DB generator 150 may request a new valid history policy to the master management server 200. If the history DB generator 150 cannot set a communication session with the master management server 200 or cannot receive a new valid history policy, the history DB generator 150 sets a preset history policy to be continuously valid, thereby updating the history DB 140.

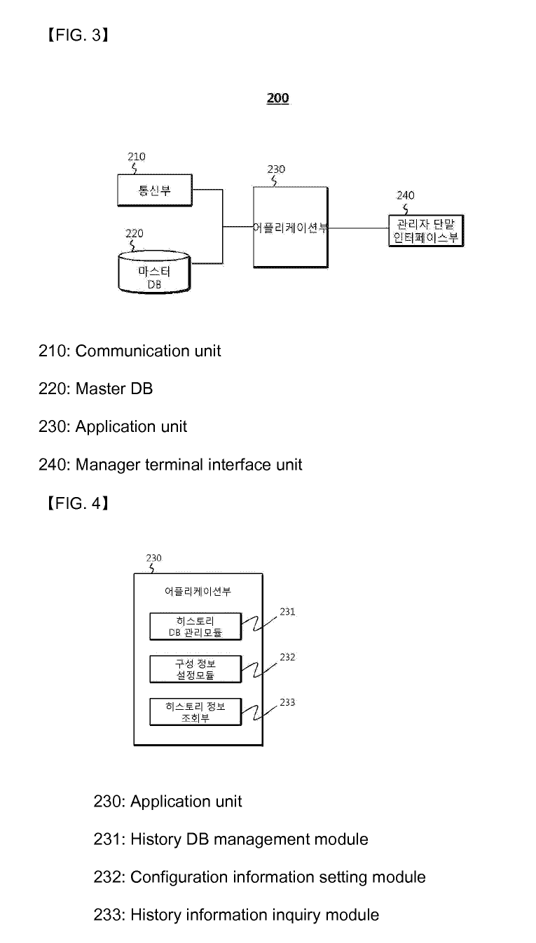

FIG. 3 is a block diagram illustrating a configuration of a master management server according to an embodiment of the present invention, and FIG. 4 is a block diagram illustrating a detail configuration of an application unit of the master management server.

In detail with reference to FIGS. 3 and 4, a master management server 200 may include a communication unit 210, a master DB 220, and an application unit 230. In the embodiment, the master management server 200 may further include a manager terminal interface unit 240.

The communication unit 210 may generate or maintain a communication environment with a management object DB server 100 or a manager terminal 300.

The master DB 220 may store information on the history policy. In one embodiment, the history policy may include item information on the management object DB 120, and update period information and a meta data type on the history DB 140.

In the embodiment, information on a history policy stored in the master DB 220 may be configured in a meta data format.

The application unit 230 may form a session with the management object DB server 100, and provide and request information on the history policy to a corresponding management object DB server 100 connected by the session so that the history DB is configured. The application unit 130 controls the communication unit 210 to form or maintain a session with the management object DB server 100.

In the embodiment, the application unit 230 may request to inquire session information with respect to a corresponding time on a session to which an error recorded is set among data stored in the history DB 140.

In the embodiment, the application unit 230 may includes a history DB management module 231, a configuration information setting module 232, and a history information inquiry module 233.

The history DB management module 231 may manage at least one of record, variation, or deletion of the history DB 140.

For example, the history DB management module 231 may provide a function determining whether the history DB 140 is activated through a registered instance search and a function capable of being added when the function is not registered. As another example, the history DB management module 231 may provide a function capable of varying a configuration of the history DB 140 through a registered instance search. As still another example, the history DB management module 231 may provide a function capable of removing at least some configuration of the history DB 140 through the registered instance search.

The configuration information setting module 232 may inquire preset information of data stored in the history DB 140, and generate or correct the history policy.

In the embodiment, the configuration information setting module 232 may provide a function capable of inquiring preset information of data stored in the history DB 140 through a registered instance search. For example, the configuration information setting module 232 may provide a function capable of setting a collection period of data, selection of a collected item, and a retention period of a history DB.

The history information inquiry module 233 may perform graphic processing with respect to data acquired from the history DB to generate reporting data.

In the embodiment, the history information inquiry module 233 may provide a function illustrating history information for each period in the form of graph and data through search of instance using a history DB function.

In the embodiment, when there is a problem in a specific session, the history information inquiry module 233 may provide a function capable of inquiring session information in detail by selecting a corresponding time.

In the embodiment, the history information inquiry module 233 may provide a function capable of specifically inquiring state information when failure occurs in a server.

The manager terminal interface unit 240 serves as interface for a user terminal 300, and converts information inquired by the history information inquiry module 233 into a data format valid in the user terminal 300 and provide the converted information.

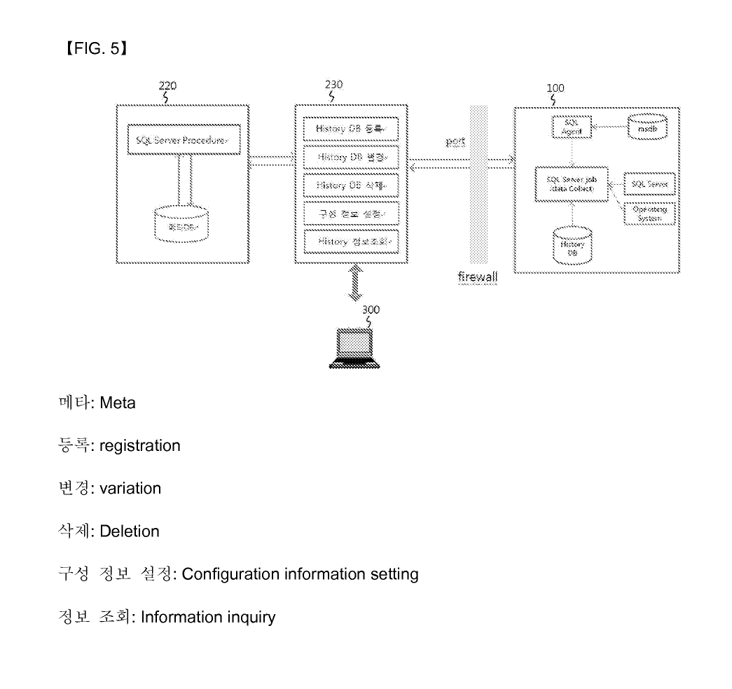

FIG. 5 is a block diagram illustrating a DB history management system according to an embodiment of the present invention.

In FIG. 5, a master DB 220 may include a DB for history policy information composed of meta data and an SQL procedure with respect thereto.

The application unit 230 may control a registration, change, or deletion function with respect to the history DB, and generate or change configuration information setting for a history policy. The application unit 230 may provide a function for inquiring history information, and may transmit inquired information to the manager terminal 300.

In the shown example, the management object DB server 100 may be configured based on SQL.

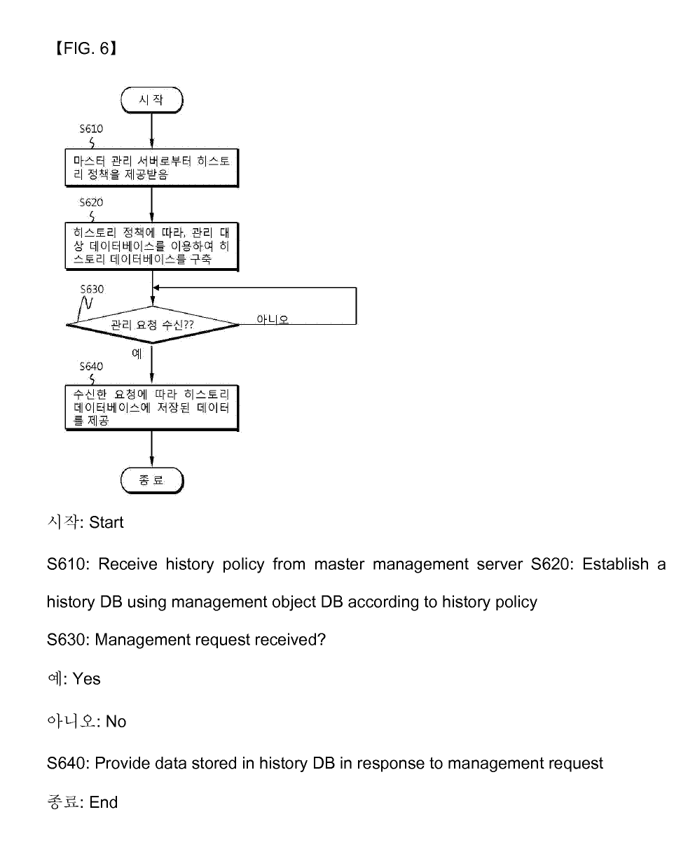

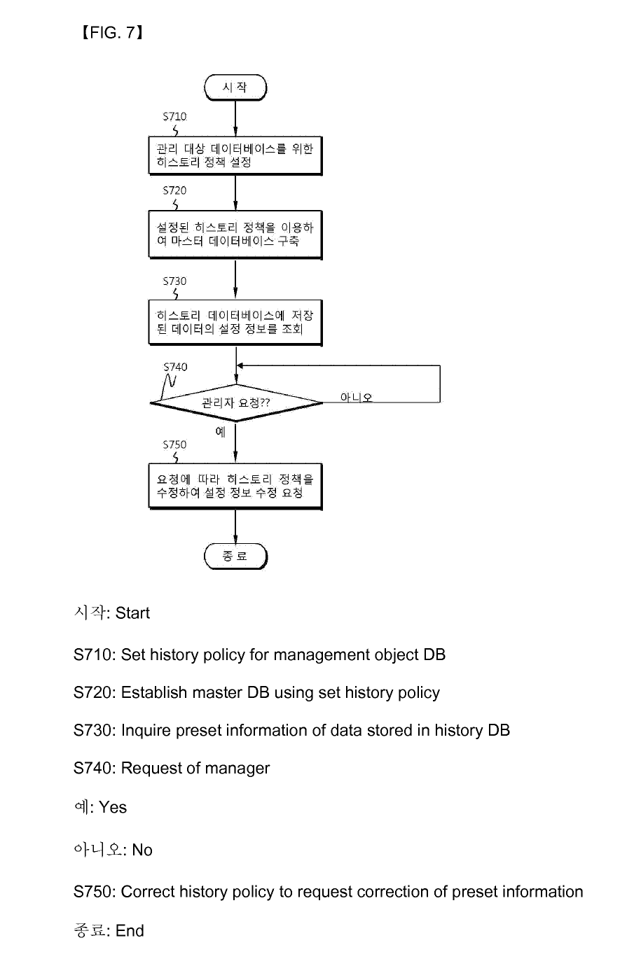

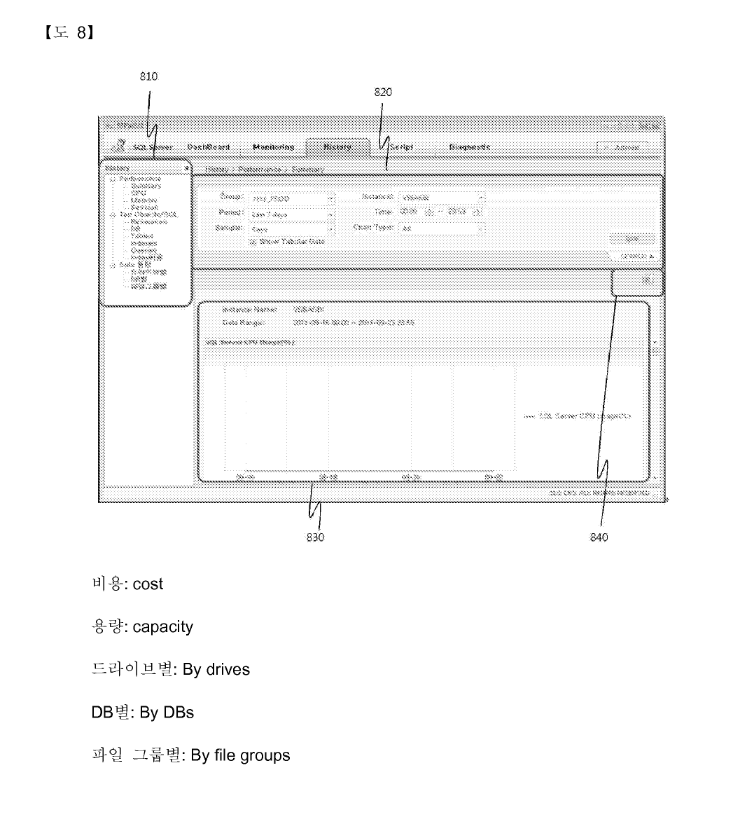

Hereinafter, various embodiments of a DB history management method will be described with reference to FIGS. 6 and 7.

Hereinafter, since following embodiments are performed by the foregoing management object DB server 100 or the master management server 200, contents corresponding the foregoing contents will not be explained to avoid repetition, but embodiments of the DB history management method can be commonly apprehended by those skilled in the art based on the foregoing description.

FIG. 6 is a flowchart illustrating a DB history management method performed by a management object DB server according to an embodiment of the present invention.

The embodiment of the DB history management method will be described in detail with reference to FIG. 6. A management objet DB server 100 may receive a history policy from a master management server 200 (step S610).

The management objet DB server 100 may extract at least some data of the management object DB 120 according to a history policy to establish a history DB 140 (step S620).

If a management request is received from the master management server 200 (Yes OF step S603), the management object DB server 100 may provide data stored in the established history DB 140 in response to the management request (step S640).

In one embodiment, the history policy may include item information on the management object DB 120, and update period information and a meta data type on the history DB 140.

In an embodiment of step S620, the management object DB server 100 may extract data corresponding to an item corresponding to item information from a management object DB 120 according to the history policy, and may re-extract data corresponding to an update period according to update period information with respect to data corresponding to the extracted item. The management object DB server 100 may convert the extracted data in a meta data format.

FIG. 7 is a flowchart illustrating a DB history management method performed by a master management server according to an embodiment of the present invention.

The embodiment of the DB history management method will be described in detail with reference to FIG. 7.

The master management server 200 may set a history policy for respectively or commonly establishing a history DB to at least one management object DB server 100 (step S710).

The master management server 200 may store information on the set history policy to establish a master DB 220 (step S720).

The master management server 200 may inquire preset information of data stored in a history DB established in the at least one management object DB (step S730), and determines whether there is a request of a manager (step S740). When there is the request of a manager, the master management server 200 may correct the history policy to request correction of the preset information (step S750).

In the embodiment, the master management server 200 may access a history DB of the at least one management object DB server 100 to extract predetermined history data, and may generate reporting data with respect to the extracted history data.

In the embodiment, the master management server 200 may inquire and provide session information on a corresponding time with respect to a session to which an error record is set among data stored in the history DB 140.

FIGS. 8 to 12 are reference diagrams illustrating an example of a DB management picture according to an embodiment of the present invention.

FIG. 8 is a reference diagram illustrating an example of a DB management picture provided to a manager.

In FIG. 8, the DB management picture may include a history information tree 810, a preset item 820 with respect to a search condition and output data, a search result picture 830, and an excel download interface 840.

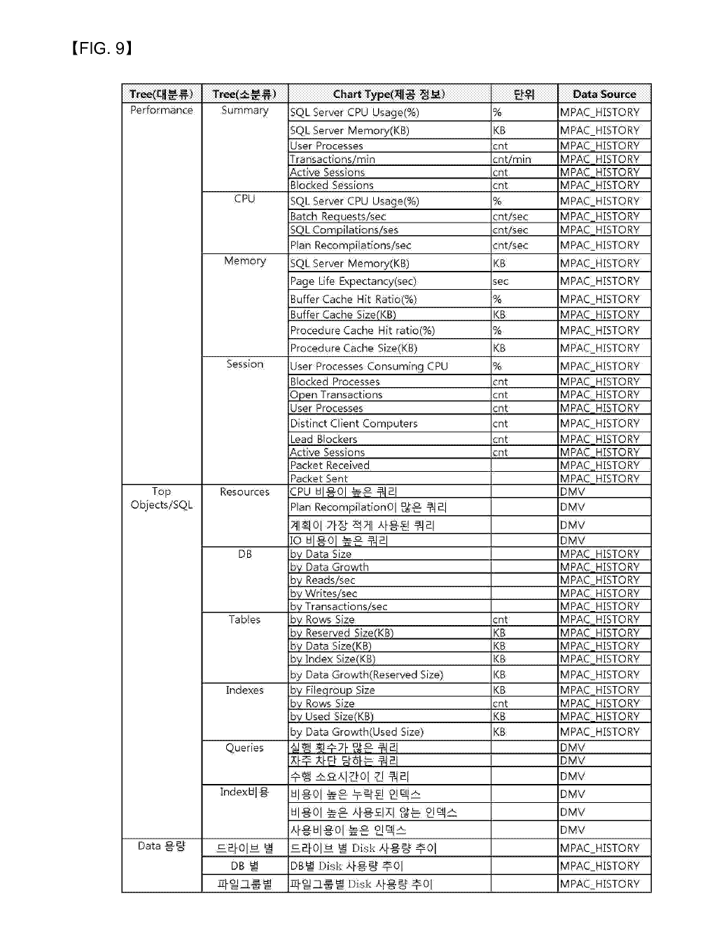

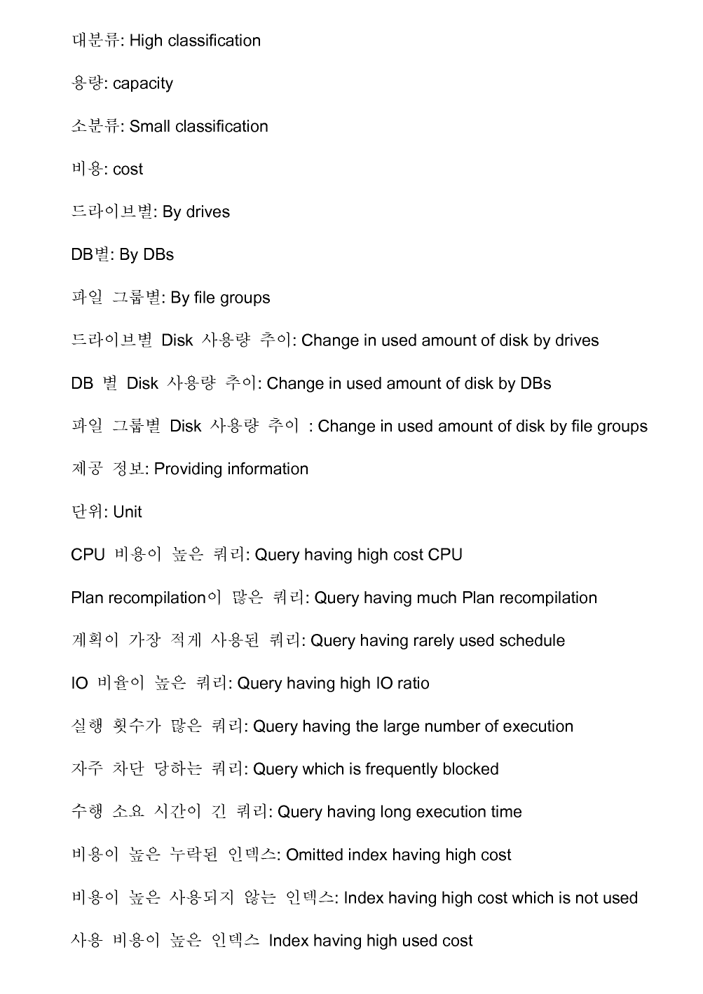

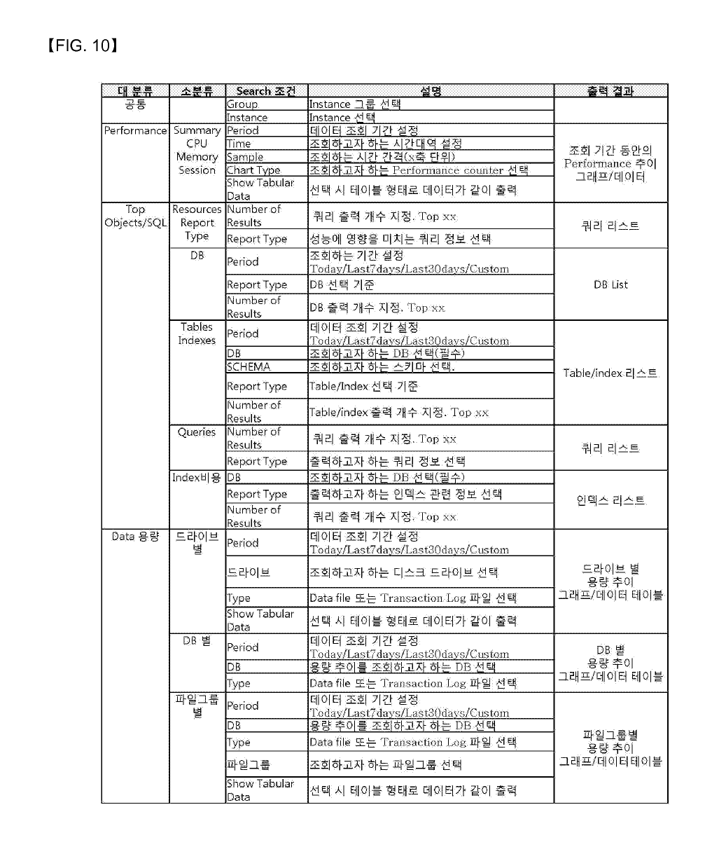

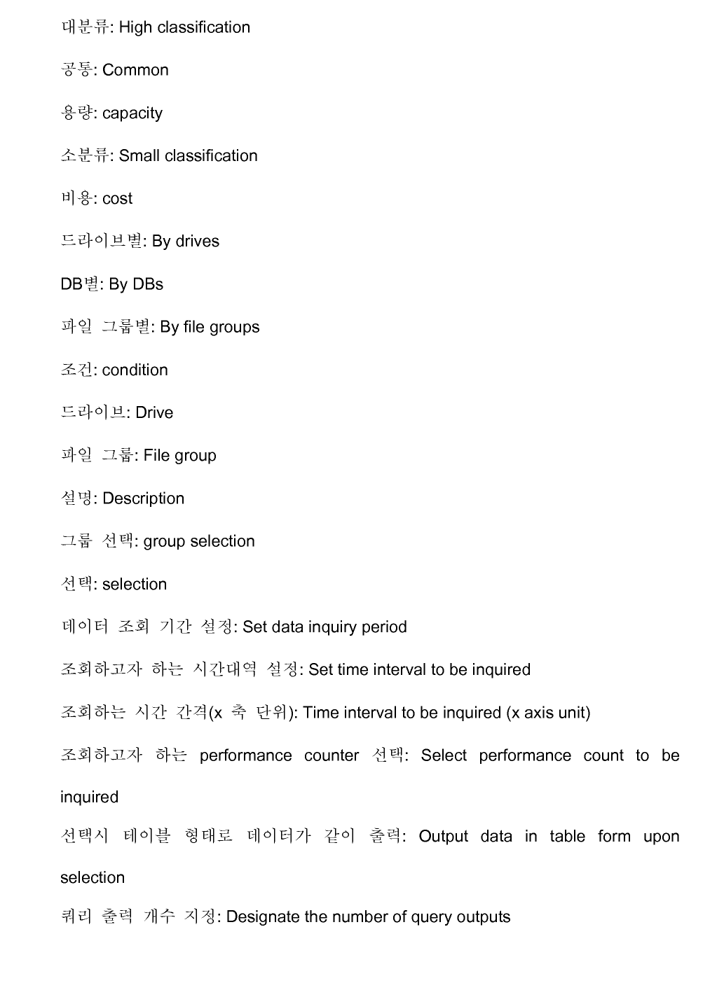

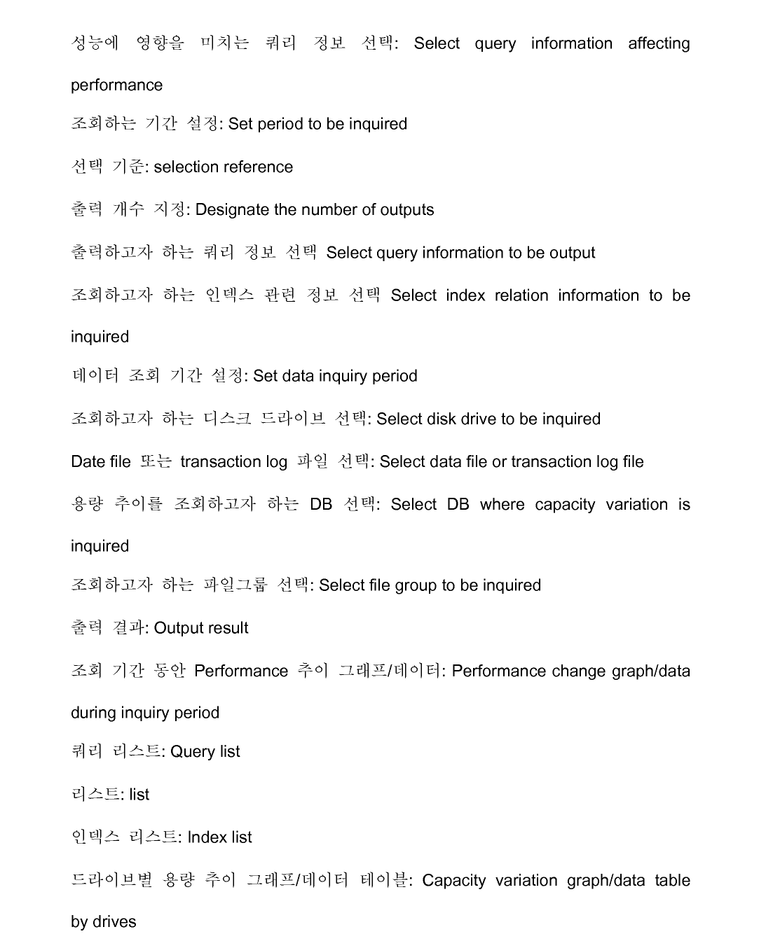

The history information tree 810 may have a tree structure with respect to history information, and a concrete example thereof is illustrated in FIG. 9.

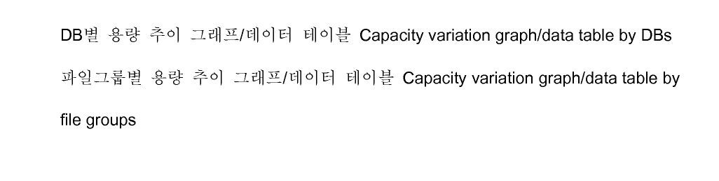

The preset item 820 with respect to a search condition and output data may provide an interface for setting a search condition and output data for the history policy. A concrete example thereof is illustrated in FIG. 10.

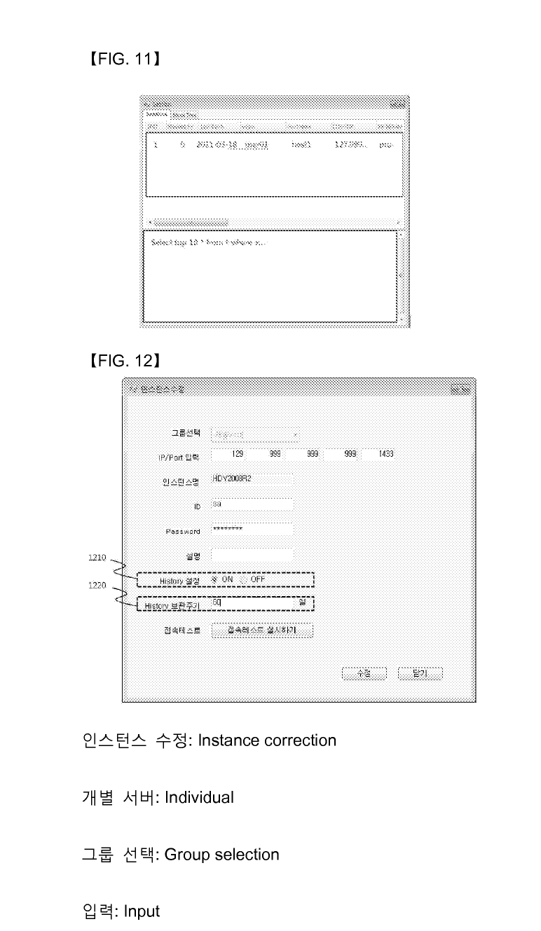

The search result picture 830 is an interface to which a search result is output. According to the embodiment, when clicking a specific time of an x axis in a case where an inquiry condition is minutes on Performance >Summary picture, a detailed session picture showing session/blocking information at the nearest time period to the time may be popped-up, session information and an SQL text of each session may be confirmed from a session tap of a pop-up window, and a block tree and an SQL text of each session may be confirmed upon selection of the block tree tap, and a concrete example thereof is illustrated in FIG. 11.

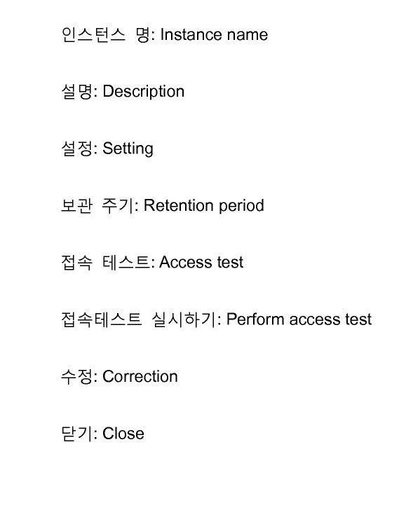

When a click event is generated by a manager, the excel download interface 840 may provide an excel picture with respect to a corresponding search result to the manager terminal 300. A concrete example thereof is illustrated in FIG. 12. History setting 1210 may select whether use of a history is used, and history retention period setting may set a retention period of the history DB. A history DB partition period may set a table partition period in the history DB.

While the invention has been shown and described with reference to a certain exemplary embodiments thereof, it will be understood by those skilled in the art that various changes in form and details may be made therein without departing from the spirit and scope of the invention as defined by the appended claims and their equivalents.

### DESCRIPTION OF REFERENCE NUMERALS

100: Management object DB server
110: Communication unit
120: Management object DB
130: DB manager
140: History DB
150: History DB generator
200: Master management server
210: Communication unit
220: Master DB
230: Application unit
231: History DB management module
232: Configuration information setting module
233: History information inquiry module
240: Manager terminal interface unit
300: Manager terminal

1. A database history management system including at least one management object database server and a master management server for managing a history of the at least one management object database server, the database history management system comprising:
the master manager server managing a history policy with respect to the at least one management object database server; and
the at least one management object database server establishing a management object database, and generating or updating a history database with respect to the management object database according to the history policy from the master management server,
wherein the master management server accesses the at least one management object database server to remotely manage a history database with respect to a corresponding management object database.

2. The database history management system of claim 1, wherein the history policy comprises at least one of item information on the management object database, and update period information and a meta data type on the history database.

3. The database history management system of claim 2, wherein the management object database server extracts data corresponding to an item corresponding to item information for each update period from the management object database according to the history policy to store the extracted data in a meta data format and to generate the history database.

4. The database history management system of claim 1, wherein the management object database server comprises:
a database manager managing accessing the management object database or the history database; and
a history database generator extracting predetermined data from the management object database according to the history policy to generate the history database.

5. The database history management system of claim 2, wherein the master management server comprises:
a master database storing information on the history policy; and
an application unit forming a session with the management object database server, and providing and requesting information on the history policy to a corresponding management object database server connected by the session so that the history data is configured.

6. A management object database server connecting with a master management server for managing a history of a management object database server and establishing and maintaining a predetermined management object database, the management object database server comprising:
a management object database storing predetermine data;
a history database generator extracting predetermined data from the management object database according to the history policy from the master management server to generate the history database; and
a history database storing the history data generated by the history database generator.

7. The management object database server of claim 6, wherein the management object database server further comprises a database manager forming a predetermined session for communication with the management object database server, and managing accessing the management object database or the history database by the master management server.

8. The management object database server of claim 7, wherein the history policy comprises at least one of item information on the management object database, and update period information and a meta data type on the history database.

9. A master management server establishing a management object database and being connected to at least one management object database server including a history database with respect to the management object database, the master management server comprising:
a master database storing a history policy for configuring the history database; and
an application unit setting the history policy, inquiring preset information of data stored in a history database established in the connected management object data or generating or correcting the history policy.

10. The master management server of claim 9, wherein the application unit comprises:
a history database management module managing at least one of record, variation, or deletion of the history database; and
a configuration information setting module inquiring the preset information of the data stored in the history database, and generating or correcting the history policy.

11. The master management server of claim 9, wherein the application unit further comprises a history information inquiry module performing graphic processing with respect to data acquired from the history database to generate reporting data, and inquiring session information on a corresponding time with respect to a session to which an error record is set among data stored in the history database.

12. A database history management method performed by a management object database server for managing a history of a management object database server and establishing and maintaining a predetermined management object database, the database history management method comprising:
(a) receiving a history policy from the master management server;
(b) extracting at least some data of the management object database according to the history policy to establish a history database; and
(c) providing data stored in the established history data in response to a request from the master management server.

13. The database history management method of claim 12, wherein the history policy comprises at least one of item information on the management object database, and update period information and a meta data type on the history database, and
wherein step (b) comprises:
extracting data corresponding to an item corresponding to item information from the management object database according to the history policy;
re-extracting data corresponding to an update period according to update period information with respect to the data corresponding to the extracted item; and
converting the extracted data in a meta data format.

14. A database history management method performed by a master management server establishing a management object database and being connected to at least one management object database server including a history database with respect to the management object database, the database history management method comprising:
(a) setting a history policy for respectively or commonly establishing the history database to the at least one management object database server;
(b) storing information on the set history policy to establish a master database; and
(c) inquiring preset information of data stored in the history database established in the at least one management object database, and correcting the history policy in response to a request to request correction of the preset information.

15. The database history management method of claim 14, further comprising:
(d1) accessing the history database of the at least one management object database server to extract predetermined history data; and
generating reporting data with respect to the extracted history data.

16. The database history management method of claim 14, further comprising (d2) inquiring and providing session information on a corresponding time with respect to a session to which an error record is set among the data stored in the history database.

17. A recording medium recording a program for executing a database history management method,
the program being driven by a master management server establishing a management object database and being connected to at least one management object database server including a history database with respect to the management object database, the program comprising:
(a) a function of setting a history policy for respectively or commonly establishing a history database to the at least one management object database server;
(b) a function of storing information on the set history policy to configure a master database; and
(c) a function of inquiring preset information of data stored in the history database established in the at least one management object database, and correcting the history policy in response to a request to request correction of the preset information.
